(19) United States
(12) Patent Application Publication
(10) Pub. No.: US 2005/0088657 A1
(43) Pub. Date: Apr. 28, 2005

(54) Optical measurment device and spectroscopic device

(76) Inventors: Toshiki Sugawara, Kodaira (JP); Masataka Shirai, Higashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/790,796

(22) Filed: Mar. 3, 2004

(30) Foreign Application Priority Data
Oct. 27, 2003 (JP) 2003-365720

(51) Int. Cl. G01B 9/02; G01J 3/28

(52) U.S. Cl. 356/454; 356/328

(57) ABSTRACT

To improve resolving power of an optical measurement device using a spectroscopic device, the optical measurement formed by use of a spectroscopic device which has a parallel interferometer (A) of high chromatic dispersion and a diffraction grating (B) of low chromatic dispersion, and the parallel interferometer (A) and the diffraction grating (B) are composed in such manner that chromatic dispersion directions of them in right angle, and a two dimensional array type light detection part (50) processing the light spread two dimensionally by the spectroscopic device (40).

### BACKGROUND OF THE INVENTION

This invention relates to an optical measurement device and an spectroscopic device, in more detail, to a spectrometer, and an optical sensor (or spectroscopic device) and an optical measurement device using the optical sensor as to detect chemistry substances or living body substances, such as hydrogen, a heavy metal, and dioxin, by an optical interferometer detecting wavelength change of the light by the substance.

Especially a spectroscopic device and optical measurement device according to this invention is suitable for an industrial plant and for basic research, such as environmental measurement, a home health checker, life science, biotechnology, and a new material.

In recent years, the concern of the citizen to food safety and an environmental problem is rising, and necessity for small and high quality substance detection equipment of which a non-specialist can also treat easily is increasing.

Moreover, on the evaluation for basic research of life science, biotechnology, a new material, etc., a miniaturization of each of a sensor and measuring instrument is required by the demand of a high through put and high quality. Especially, in a field of biotechnology relation, clinical inspection, various plants (a chemistry plant, food plant, etc.) and environmental measurement, a spectrum measurement is fundamental for an optical measuring method and is applicable for a photometer, a fluorescence photometer, a micro plate photometer, atomic absorption spectrometer, mercury measurement equipment, particle distribution measurement equipment.

A parallel interference spectrometer using a dielectric multilayer film of high reflection factor is used as an effective spectroscopic device, and it is known that a parallel interference spectrometer has high chromatic dispersion in comparison with dispersive devices such as prism and diffraction grating.

Wave branching filter used for communication using the interference meter is shown in a document (M. Shirasaki, Optics Letters Vol. 21 No. 5 pp 366˜368).

FIGS. 1 and 2 show a construction of the wavelength divider using the interference meter and the section structure of a substrate 30 respectively.

In this wavelength divider, input light is focused by lens part 20 and inputted on interference plate 30. As shown in FIG. 2, a parallel interference plate 30.

One surface of transparent substrate 34 forming the parallel interference plate 30 is courted with reflecting film 31 having reflection factor 100% and with antireflection coating 33. The other surface of transparent substrate 34 is coated with reflecting film 32 having reflection factor 95%. Light beam focused by lens part 20 is inputted into antireflection coating 33 of parallel interference plate 30 which inclined a little (an incidence angle is no less than 3.5°)

Focus lens part 20 and parallel interference plate 30 are arranged so that inputted light may be introduced into near the boundary of reflecting film 31 and so that the most focused potion may be on reflecting film 32.

The light which passed antireflection coating 33 passes reflecting film 32 only 5%, and 95% of inputted light returns in interference plate 30 and hits on parallel reflecting film 31 The light which hit reflecting film 31 is reflected by 100% of reflection factor, is hit reflecting film 32 again. And only 5% of reflected light is outputted from parallel interference plate 30 repeatedly.

Under these circumstances, since the beam is narrowed down by focus lens part 20 at once. For this reason, light beam spreads gradually. On this reason, each of output light of 5% causes interference, and interference plate 30 acts like penetrated type diffraction grating, the wavelength intensity changes according to the output angle. The relationship between this wavelength and the output angle, i.e., chromatic dispersion characteristic, is shown in FIG. 3.

FIG. 3 shows that the very big chromatic dispersion angle of 0.4-0.8 degrees/nm is acquired. In this case, since the thickness of basis plate is 100 μm, the wavelength periodicity in every 8 nm exists owing to this optical pass difference.

In order to make it function as a wavelength divider, two or more focus lens and fibers are arranged in the position where optical intensity becomes the largest according to wavelength and light of desired wavelength is wavelength divided.

### SUMMARY OF THE INVENTION

As described above, a parallel interference spectrometer is useful as a high quality chromatic dispersive device, but an optical characteristic of the parallel interference spectrometer has wavelength periodicity (FSR: Free Spectral Range), since it utilizes multireflection (resonance phenomenon) of light.

Therefore, in a case when it is used as a small and high-resolution spectroscopic device, there is a problem that it is impossible to separate the light of the wavelength for every FSR. Namely, intensity distribution of diffraction light becomes a striped pattern to one dimension, and that with which two or more wavelength ingredients overlapped appears as strength of light. Therefore, in order to separate wavelength, advanced signal processing is needed, and a non-specialist cannot use it. And, it is usable in a field of communication, but there is a problem that it cannot be used as a measurement device needs to detect specified wavelength component.

In order to solve the above problems, a spectroscopic device (or spectrometer) according to this invention uses a parallel interference spectrometer having high chromatic dispersion characteristic and a dispersive device having chromatic dispersion characteristic being lower than that of the parallel interference spectrometer such as diffraction grating. The parallel interference spectrometer and the dispersive device are combined at position separated by a predetermined distance in such manner that direction of chromatic dispersion of the parallel interference spectrometer and direction of the chromatic dispersion of dispersive device may be different. As to a different direction of the two-chromatic dispersion direction, right angle is desirable, but it is not limited to the right angle.

Further, this invention forms an optical measurement device which displays wavelength distribution of a sample to be detected as a two dimensional picture, by use of photoelectric conversion means such as CCD, image intensifier which detects two dimensional light spread by the said spectroscopic device and picture signal processing means.

More over, a preferable embodiment of this invention is realized to miniaturize of the device by integrating of elements. That is, a dispersive device such as a diffraction grating, and parts of a photoelectric conversion means are integrated on a parallel interference plate forming a parallel interference spectrometer.

As explained herein after, a interferometer according to this invention can separate light of each wavelength of wavelength periodicity (FSR: Free Spectral Range) by use of photoelectric conversion means arranged two dimensionally, since the parallel interference spectrometer and other dispersive device are composed in such manner that chromatic dispersion directions of them may be different, and since interference light is spread two dimensionally by simple method.

Moreover, distance between spectroscopic device and a photoelectric conversion means can be shortened, the miniaturization of spectroscopic device can be realized, and it becomes possible optical measurement device and to realize especially carried type optical measurement device.

Using the optical measurement equipment according to this invention, it becomes possible to build an optical resolution measurement system being economical, small size and high quantity in a field of an industrial plant, environmental measurement, life science, and biotechnology.

### BRIEF DESCRIPTION OF DRAWINGS

FIG. 1 shows construction of a chromatic dispersive device due to parallel interference plate used for an optical wavelength divider.

FIG. 2 shows a cross section of a parallel interferometer shown in FIG. 1

FIG. 3 shows a picture showing a chromatic dispersion characteristic obtained by a conventional parallel interferometer

FIG. 4 shows separated views explaining construction and principle of one embodiment according to this invention.

FIG. 5 shows a conceptional view of other embodiment of an optical measurement device according to this invention.

FIG. 6 shows a cross sectional view of other embodiment of an optical measurement device according to this invention.

FIG. 7 shows a cross-sectional view of parallel interference plate used in a spectroscopic device according to this invention.

FIG. 8 shows a cross sectional view of parallel interference plate used in a spectroscopic device according to this invention.

FIG. 9 shows a cross sectional view of parallel interference plate used in a spectroscopic device according to this invention.

FIG. 10 shows chromatic dispersion characteristic representing experiment result of one embodiment of optical measurement device according to this invention.

### DETAILED DESCRIPTION OF THE PREFERRED EMBODIMENTS

The present invention will be now described in detail by way of example with reference to the accompanying drawings.

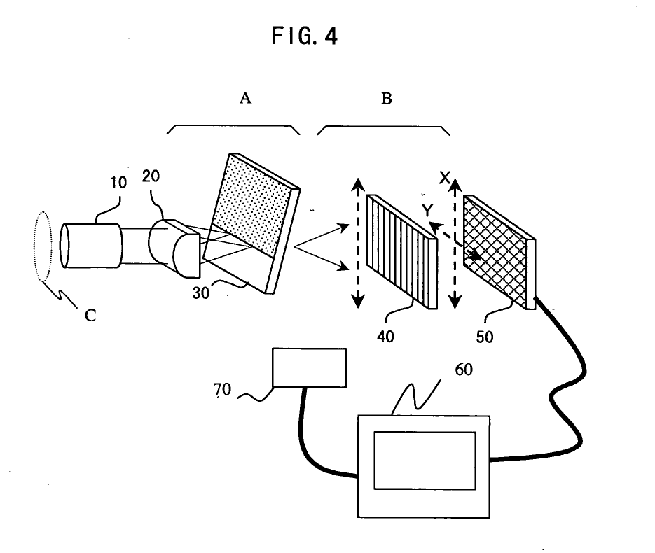

FIG. 4 is a decomposition perspective diagram showing composition and principle of one embodiment of an optical measurement device, which used spectroscopic device according to this invention.

A spectroscopic device according to this invention has a parallel interference spectrometer A having chromatic dispersion characteristic, and a dispersive device B having chromatic lower dispersion characteristic smaller than that of the interference spectrometer A. The parallel interference spectrometer A and dispersive device B are arranged and constituted in such manner that direction X of chromatic dispersion of spectrometer A is different from direction Y of the chromatic dispersion of the dispersive device B.

Parallel interference spectrometer A is constituted by collimator 10, focus lens part 20 and parallel interference plate 30. Dispersive device B is constituted by penetrate type diffraction grating 40.

So as to constitute an optical measurement device, two dimensional array type photodetector part 50 is provided at output side of said spectroscopic device.

Signal from the photodetector part 50 is processed by picture processing device 80, and the result of measuring is displayed.

The light passed through sample C to be measured is collimated by collimator 10, is focused by focus lens part 20 and is inputted on parallel interference plate 30.

As shown in FIG. 2, parallel interference plate 30 is formed by transparent substrate 34. One surface of transparent substrate 34 is coated by reflecting film 31 of reflection factor 100% and antireflection coating 33 separated in the shape of a straight line, and the other whole surface side of transparent substrate 34 is coated by reflecting film 32 of beyond reflection factor 90%.

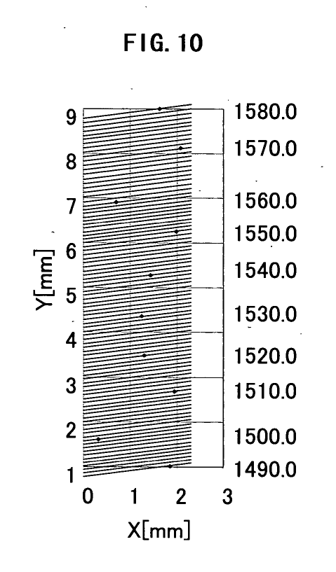

Picture processing device 60 is a signal processing device such as a microprocessor, although a camera may be used. Picture processing device 60 has a standard scale data corresponding to standard temperature, i.e. a data representing wavelength and optical intensity distribution shown in FIG. 10, which is explained after. The data of the position relationship showing light intensity distribution is prepared beforehand. And picture processing device 60 expresses to a part for part of the wavelength detected by spectroscopic device as the signal of luminosity and a color reason.

Thermometer 70, which detects the circumference temperature of spectroscopic device, is prepared, and it is made to proofread said standard scale data based on temperature information detected with the thermometer 70.

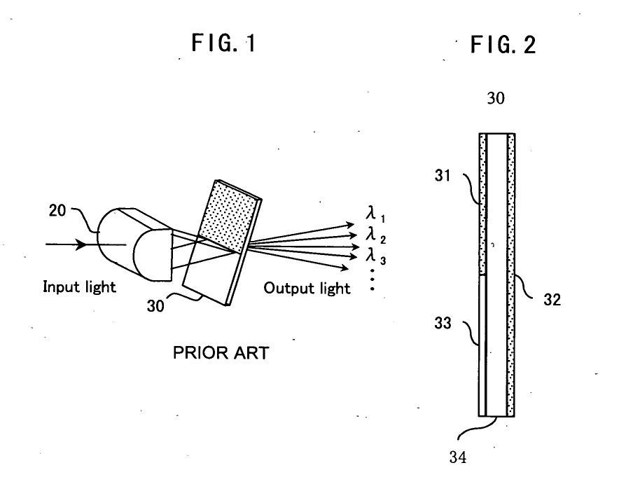

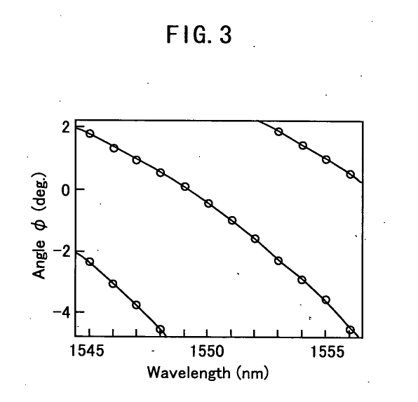

As stated in connection with FIG. 1, the light focused by focus lens part 20 is inputted on antireflection coating 33 of parallel interference plate 30 leaned aslant slightly. The light radiated from parallel interference plate 30 causes interference and wavelength intensity changes according to the output angle (direction X).

Penetrated type diffraction grating 40 give the interference light penetrated from penetrate type diffraction grating 40 chromatic dispersion in the different direction from the direction of being generated in interference spectrometer (direction Y).

Thus, 2-dimensional array type photpdetector part 50 detects the light, which is given wavelength distribution in two directions.

Although directions X and Y are shown perpendicularly in FIG. 4, said two directions might be other angle (larger than 0 degree), since out put light is spread in two dimensions.

As described in more detail in FIG. 10 later, since the light is outputted in same wavelength periodicity and in the same direction by penetrated type diffraction grating 40, and is separated in the different direction in two dimensions, the problem of the wavelength periodicity whose wavelength separation was not completed in 1-dimensional detection, is removed by two-dimensional array type light detection part 50.

Two-dimensional array type photodetector part 50 is formed by detection elements (photoelectric conversion element), such as a camera, CCD (Charge Coupled Device), or an image intensifier.

Especially by using a element detecting a light having a wavelength of an infrared zone from near infrared zone, it becomes possible to detect a spectrum of infrared or near rays and it becomes possible to apply this invention to the broad field of a plant, environmental measurement, health, a medical division-into-equal-parts field, etc.

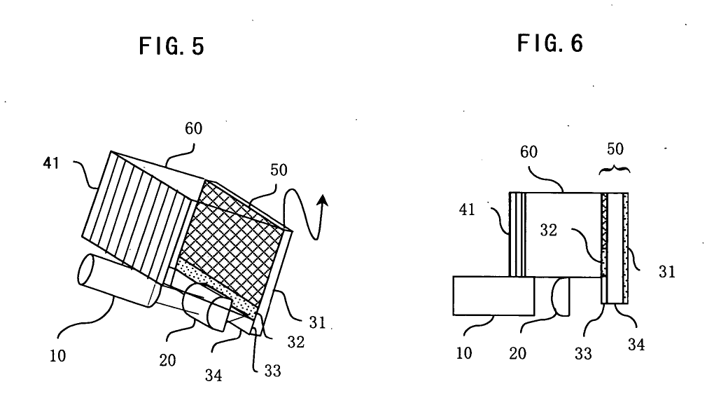

FIGS. 5 and 6 show perspective diagram and sectional side elevation of a second embodiment of spectroscopic device according to this invention respectively.

This embodiment of spectroscopic device comprises fixation part 60 with collimator 10, focus lens part 20, parallel interference plate 30, reflection type diffraction grating 41, and two-dimensional array type light detectionpart 50. The light from collimator 10 is focused by focus lens part 20, and is carried out to parallel interference plate 30.

This parallel interference plate 30 has transparent substrate 34. One surface of the transparent substrate 34 is coated by reflecting film 32 of reflection factor being no less than 90% and antireflection coating 33 in such manner that boundary of the reflecting film 32 and the antireflection coating 33 may be a straight line. The whole surface of the transparent substrate 34 is coated by reflecting film 31 of reflection factor 100%. 2-dimensional array type photodetector part 50 is accumulated on the substrate in side of reflecting film 32 and on opposite side of the antireflection coating 33.

As described in connection with FIG. 1, a light focused by focus lens part 20 is incidented in antireflection coating 33 of parallel interference plate inclined slightly. The inputted light repeats reflection between reflecting film 31 and reflecting film 32, output light passed through reflecting film 32 of parallel interference plate 30 causes interference, wavelength intensity of the output light is changed depending on output angle. Reflection type diffraction grating 41 is arranged so as to give chromatic dispersion in a direction crossing at right angle a direction of the time said parallel interferometer (at position separated by predetermined distance from reflecting film 32)

As described above, two dimensional array type photodetector part 50 detects a light of which chromatic dispersion is given in two different directions by said parallel interference spectrometer and reflection type diffraction grating 41. In the spectroscopic device shown in FIGS. 5 and 6, two dimensional array type photodetector part 50 is made by sticking it on transparent substrate 34. Fixing part 60 determines position relationship of substrate 34 forming parallel interferometer, reflection type diffraction grating 41 and two dimensional array type light detection part 50. The fixing part 60 may be space or transparent material. Furthermore, the position relation between collimator 10 and focus lens part 20 may be fixed. Moreover, it is desirable that fixing part 60 is made of transparent material for light of wavelength to be measured, and in region of visible or near infrared that fixing part 60 is made of glass of synthetic quartz etc. By such composition, reflection type diffraction grating 41 divides two dimensionally light radiated in the same direction depending on wavelength periodicity thereof to lights having dispersions in different directions. Accordingly lights having dispersions in different directions can be detected by the two dimensional array type photodetector part 50.

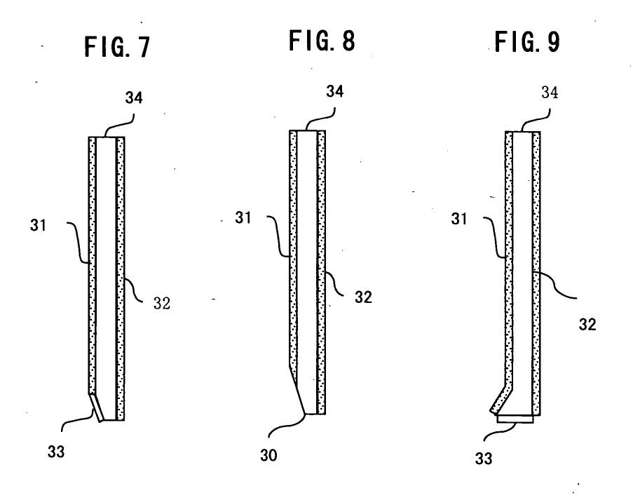

FIGS. 7 and 8 are the sectional side elevation showing the composition of parallel interference plate used for spectroscopic device of this invention. The incidence part of the light of parallel interference plate 30 may not necessarily have parallel reflecting film 31 and 32.

In parallel interference plates shown in FIGS. 7 and 8, part 33 which carries out incidence of transparent substrate 34 is made thin, and in parallel interference plate shown in FIG. 9, width between reflecting film 31 and 32 for part through which a light is inputted, is formed thick.

In order to acquire such parallel interference plates, such forms are realized by scraping or processes such as making the basis plate 34 for a trapezoid part rival further etc.

FIG. 8 shows a parallel interference plate made by more simple process in compared with the composition of parallel interference plate shown in FIG. 7. The simple process is attained by excluding antireflection coating 33.

Moreover, in the parallel interference plate shown in FIG. 9, it is possible to change optical pass of a light inputted into antireflection coating 33, since the light is reflected to a part being inclined at first. Therefore, arrangement of collimator 10 or focus lens part 20 can be arbitrarily taken by changing an angle of slanting part.

FIG. 10 shows relationship of optical wavelength on two dimensional plane of a received interference light presenting result of experiment, which carried by optical measurement device using a spectroscopic device according to present invention.

In the experiment, a parallel interference plate shown in FIG. 9, reflecting films 31 and 32 are dielectric multilayer film, each of which reflection factors are 100% and 98% respectively. Synthetic quartz having little loss optically and small temperature expansion rate (<=10⁻⁷/degree C.) was used for transparent substrate 34.

Moreover, diffraction grating was reflection type. The infrared camera was used for two dimensional array type photodetector part 50.

FIG. 10 shows changes of bright points displayed on the infrared camera in case that wavelength of a wavelength variable light source is changed in a range of from about 1490 nm to 1580 nm. In FIG. 10, plots (●) represent positions of bright points when wavelengths of which are 1490, 1500, - - - 1580 nm and the case of being every 10 nm, and the straight line shows the motion of bright points auxiliary.

The direction X in FIG. 10, shows a chromatic dispersion direction occurred by parallel spectrometer, and the direction Y shows chromatic dispersion direction occurred by a reflection type diffraction grating. The unit in FIG. 10 shows correspondence to the position on an infrared camera.

The bright points changes in the direction of upper right (auxiliary line in the figure) from the lower left, when the wavelength is lengthened.

Since a parallel spectrometer has wavelength periodicity, if it goes to the place of a little more than 2 cm of the right-hand side X-axis, it will move to the place with 0 cm of left-hand side X-axis. At this time, since wavelength distribution is given by a reflection type diffraction grating in the direction of Y, only a few will move to the upper position from the point started at first.

Thus, by making wavelength long, it can be seen that bright points moves upwards from under the right from the left. At the above experiment, the thickness of basis plate was about 1 mm, and the wavelength cycle was 100 GHz (about 0.8 nm). When the amount of movements by wavelength distribution of these X directions and the direction of Y was measured, the parallel spectrometer obtained amount of wavelength distributions about 30 times the amount of wavelength distributions of reflection type diffraction grating, and the effect of high resolution ability of this invention was confirm.

Although the parallel interference plate of the spectroscopic device in the experiment is used by synthetic quartz having small temperature expansion coefficient as parallel interference plate, the usual glass plate may be used.

Since the thickness of a basis plate will change slightly if temperature changes, the optical characteristic also changes a little, that is, the shift of a wavelength distribution angle occurs by the change of the temperature.

Therefore, in order to realize highly precise spectroscopic device, the measure to temperature change is also important.

One method is to reduce the temperature dependability of each optical element and another method is to establish a proofreading means.

As an example of a proofreading means, as shown in FIG. 4, the temperature detection device 70 detecting a temperature of spectroscopic device, and reference standard scale data corresponding to standard temperature such as the data of an parallel slash view shown in FIG. 10 are prepared in the signal processing device 80, and it is made to proofread standard scale data based on the temperature information detected with the said thermometer.

Corresponding to the temperature environment of sample and row part equipment, highly precise spectroscopic device is realizable.

1. A spectroscopic device comprises:
a parallel interference spectrometer having chromatic dispersion characteristic; and
a dispersive device having chromatic dispersion characteristic smaller than that of a said parallel interference spectrometer,
wherein the parallel interference spectrometer and the dispersive device are arranged in the position of a predetermined distance separated and in such manner that direction of chromatic dispersion of the parallel interference spectrometer and direction of chromatic dispersion of the dispersive device may be different.

2. A spectroscopic device according to claim 1, wherein said parallel interference spectrometer has focusing lens part and parallel interference plate, and said parallel interference plate has coated with a first reflecting film having boundary with light input plane on one surface of a transparent substrate, on the other surface of the transparent substrate, second reflecting film having reflection factor being smaller than that of said reflecting film is formed, and said dispersive device is arranged so as to diffract light passed through said second reflecting film.

3. A spectroscopic device according to claim 2, wherein reflection factor of a light input plane of said parallel interference plate is under 10%, reflection factor of said first reflecting film is no less than 90% and, and reflection factor of said second reflecting film is no less than 80%.

4. A spectroscopic device according to claim 1, wherein said parallel interference spectrometer has a focusing lens part and a parallel interference plate, said parallel interference plate has, on one surface of transparent substrate, an input plane to which light from said focus lens part is inputted, and first reflecting film having a boundary with said input plane, on the other surface, second reflecting film having reflection factor being larger than that of a said reflecting film, said dispersive device is arranged so as to diffract light passed through said first reflecting film and so as to output diffracted light on side of said parallel interference plate.

5. A spectroscopic device according to claim 4, wherein reflection factor of light input plane of the said parallel interference plate is under 10%, reflection factor of said first reflecting film is under 80%, and reflection factor of said second reflecting film is under 90%.

6. A spectroscopic device according to claim 4, wherein said dispersive device is formed by a reflection type diffraction grating, and formed in size being under 3×3 centimeters.

7. A spectroscopic device according to claim 1, wherein temperature expansion coefficient of said transparent substrate is in a range of 10⁻⁷/° C.

8. A spectroscopic device according to claim 1, wherein said dispersive device is formed by at least one of a prism, a diffraction grating or a parallel interference plate.

9. An optical measurement device comprises:
a spectroscopic device according to claim 1; and
a light detection part detecting two dimensional distribution of light dispered by said parallel interference spectrometer and dispersive device in said spectroscopic device.

10. An optical measurement device according to claim 9, wherein said light detection part comprises:
a photoelectric conversion part being any of a two dimensional arrayed type photo-detector, CCD, camera, or image intensifier; and
a signal processing part displaying information of two dimensional distributions of light obtained by the photoelectric conversion part as a two dimensional plane picture or converting and displaying the information as a relationship between wavelength and light intensity.

11. An optical measurement device comprises:
a spectroscopic device according to claim 4; and
a light detection part detecting a two dimensional distribution of a light dispered by said parallel interference spectrometer and dispersive device between said dispersive device of said spectroscopic device and said parallel interference.

12. An optical measurement device according to claim 11: wherein the photoelectric conversion part forming said light detection part has a fixing part made from transparent material integrated in side of said first reflecting film of the transparent substrate and between said parallel interference plate and the dispersive device.

13. An optical measurement device according to claim 10: which further comprises a means for detecting of a temperature or a distortion of the said transparent substrate, and said signal processing part has a means for proofreading the displayed information of the optical two dimensional distribution depending on the said information of the temperature or a distortion.

14. A spectroscopic device according to claim 1: wherein
said transparent substrate and fixing part is made of a element having low loss for a light of region from near infrared to infrared; and,
the light detection part is made of a element sensitive to a light of region from near infrared to infrared.
